(19) United States
(12) Patent Application Publication
(10) Pub. No.: US 2024/0410677 A1
(43) Pub. Date: Dec. 12, 2024

(54) METHOD FOR PRODUCING A PROTECTIVE ELEMENT, FORMED OF A PLURALITY OF INDIVIDUAL PROFILES, FOR ARMORING A MOTOR VEHICLE, AND PROTECTIVE ELEMENT PRODUCED BY THE METHOD

(71) Applicant: BENTELER AUTOMOBILTECHNIK GMBH, Paderborn (DE)

(72) Inventors: CHRISTIAN RUESING, Paderborn (DE); Dennis Schomberg, Oerlinghausen (DE); Frank Hoecker, Ibbenbueren (DE)

(73) Assignee: BENTELER AUTOMOBILTECHNIK GMBH, Paderborn (DE)

(21) Appl. No.: 18/733,885

(22) Filed: Jun. 5, 2024

(30) Foreign Application Priority Data
Jun. 7, 2023 (EP) 23177930.7

(51) Int. Cl. F41H 7/04; B21D 53/88; B23K 26/24

(52) U.S. Cl. CPC F41H 7/04; B21D 53/88; B23K 26/24

(57) ABSTRACT

A method for producing a protective element which is formed of individual profiles for armoring a motor vehicle. The method includes providing the individual profiles from a same steel alloy or from different steel alloys, welding the individual profiles to provide a preform, heating the preform to a temperature which is higher than an austenitizing temperature of the steel alloy or, if the individual profiles are provided from different steel alloys, to a temperature of the steel alloy having a highest austenitizing temperature, inserting the preform into a hot-forming mold, subjecting the preform to a final shaping in the hot-forming mold to provide the protective element, and hardening the protective element in the hot-forming mold. The welding is performed with a formation of at least two weld seams. A first weld seam is thereby located further away from a strike-facing side of the individual profiles than a second well seam.

### CROSS REFERENCE TO PRIOR APPLICATIONS

Priority is claimed to European Patent Application No. EP 23177930.7, filed Jun. 7, 2023. The entire disclosure of said application is incorporated by reference herein.

### FIELD

The present invention relates to a method for producing a protective element, which is formed of a plurality of individual profiles, for armoring a motor vehicle. The present invention also relates to a protective element produced by the method.

### BACKGROUND

Such protective elements or armoring elements of a motor vehicle are used in military motor vehicles as well as in non-military protection vehicles for armoring the vehicle in order to protect the vehicle from ballistic attack and detonation effects. Such protective elements for motor vehicles are often produced from formed parts which are formed from flat plates or metal sheets. In the case of such formed parts, however, the shaping technique which is used leads to the formation of bending radii which can adversely affect the protective function in the motor vehicle. This is because bending reduces the protected area since projectiles are deflected at the bending radii and can undesirably penetrate the vehicle interior. The smaller the bending radius, i.e., the larger the bend itself, the smaller the material thickness at the bending point of the workpiece. The strength of the workpiece is, however, also reduced in the case of large bending radii, i.e., with a slight bending. The use of such formed parts for protective elements in motor vehicles is in this respect not sufficient to provide the protective function of the protective element, in particular in the region of the bend.

Such protective elements can be produced from flat or bent blanks or from individual profiles of already hardened protection steel. These blanks or individual profiles are here welded together. Forming is, however, limited due to the high hardness of such protection steels. There is also a loss of hardness, and thus of the protective action of the protective element that is to be produced, in the weld seam, or in the heat-affected zone between the individual blanks or individual profiles.

DE 10 2017 102 547 A1 describes a protective element which already has good protective action. The individual profiles have to date been welded with austenitic filler metal after hardening to provide the protective element. As a result of the heat-affected zone caused by the welding process, however, the protective element is tempered in this region and is no longer strike-resistant. The soft austenitic weld seam is likewise not strike-resistant. An austenitic welding filler metal is required, however, in order to compensate for the stresses during welding.

### SUMMARY

An aspect of the present invention is to provide a method for producing a protective element, which is formed of a plurality of individual profiles, for armoring a motor vehicle, wherein the protective element maintains the necessary protective action over its entire extent without experiencing a weakening and thus losses in terms of protective power during production. A further aspect of the present invention is to also provide such a protective element.

In an embodiment, the present invention provides a method for producing a protective element which is formed of individual profiles for armoring a motor vehicle. At least two of the individual profiles are arranged adjacent to one another. The method includes providing the individual profiles from a same steel alloy or from different steel alloys, welding the individual profiles to provide a preform of the protective element, heating the preform to a temperature which is higher than an austenitizing temperature of the steel alloy or, if the individual profiles are provided from different steel alloys, to a temperature of the steel alloy having a highest austenitizing temperature, inserting the preform into a hot-forming mold, subjecting the preform to a final shaping in the hot-forming mold to provide the protective element, and hardening the protective element in the hot-forming mold. The welding of the individual profiles to provide the preform of the protective element is performed with a formation of at least two weld seams. A first weld seam of the at least two weld seams is located further away from a strike-facing side of the individual profiles than a second well seam of the at least two weld seams.

### BRIEF DESCRIPTION OF THE DRAWINGS

The present invention is described in greater detail below on the basis of embodiments and of the drawings in which:

FIG. 1 shows an exemplary embodiment of a protective element according to the present invention in the form of a B-pillar in a top view;

FIG. 2 shows a sectional representation of the B-pillar of FIG. 1 along the sectional plane A-A;

FIG. 3 shows a first step of a first method according to the present invention for producing a protective element formed of a plurality of individual profiles;

FIG. 4 shows a second step of the first method according to the present invention for producing a protective element formed of a plurality of individual profiles;

FIG. 5 shows a first step of a second method according to the present invention for producing a protective element formed of a plurality of individual profiles;

FIG. 6 shows a second step of the second method according to the present invention for producing a protective element formed of a plurality of individual profiles;

FIG. 7 shows a first step of a third method according to the present invention for producing a protective element formed of a plurality of individual profiles;

FIG. 8 shows a second step of the third method according to the present invention for producing a protective element formed of a plurality of individual profiles;

FIG. 9 shows a third step of the third method according to the present invention for producing a protective element formed of a plurality of individual profiles;

FIG. 10 shows a fourth method according to the present invention for producing a protective element formed of a plurality of individual profiles; and

FIG. 11 shows a fifth method according to the present invention for producing a protective element formed of a plurality of individual profiles.

### DETAILED DESCRIPTION

The method according to the present invention for producing a protective element, which is formed of a plurality of individual profiles, for armoring a motor vehicle, in which at least two of the individual profiles are arranged adjacent to one another, comprises the following method steps:
a) providing the individual profiles from the same steel alloy or from different steel alloys,
b) welding the individual profiles to provide a preform of the protective element,
c) heating the preform to a temperature which is higher than the austenitizing temperature of the steel alloy with the higher austenitizing temperature,
d) inserting the preform into a hot-forming mold, and
e) subjecting the preform to final shaping in the hot-forming mold to provide the protective element,

wherein, the welding in step b) is carried out with the formation of at least a first weld seam and a second weld seam between two individual profiles, the first weld seam is located further away from a strike-facing side of the individual profiles than the second weld seam, and the protective element 1 is hardened in a final method step.

It is particularly advantageous in the method according to the present invention for producing a protective element formed of a plurality of individual profiles that, for example, shaping by bending must no longer take place in the shaping step during final shaping in order to orient the original individual profiles relative to one another at the desired angle that is different from 180°. In this basic form of the protective element to be produced, the individual profiles are already oriented and welded together at the desired angle relative to one another. During final shaping, no bending radii, which would mean weakening of the protective element to be produced and thus of the protective action thereof, are thus produced in the region of the weld seams. In particular in the region of the weld seams between the individual profiles of the protective element, where the actual final shaping takes place, sharp edges can thus in particular be produced by the use of two weld seams, without the need for bending radii, which occur during bending processes in final shaping, for arranging the individual profiles relative to one another. Such sharp edges offer a significantly higher protective action for protective elements according to the present invention than do conventional bending radii of known protective elements because the surface area of the bend in the region of the weld seams, and thus the likelihood of a projectile being deflected in the region of the sharp edges, is significantly reduced. The final method step, in which the protective element is hardened, reduces the size of the heat-affected zones generated by welding adjacent to the weld seams. This results in significantly improved strike resistance close to the weld seams. If the position of the weld seam is taken into consideration in the geometry of the component in respect of the strike angle, significantly improved strike resistance is also obtained with a soft weld seam. This can additionally be further improved by a combination of soft and hard weld seams. A hard filler metal can be used on the strike face, wherein a soft connecting weld seam can be applied on the rear side. This results in a relatively uniform hardness profile on the strike face without a relevant weak point after the final shaping and press hardening.

By heating the preform to a temperature which is higher than the austenitizing temperature of the steel alloy with the higher austenitizing temperature, a structural change takes place within the metal in the steels, or in metals which can also be used for armoring, such as, for example, magnesium alloys, aluminum alloys and titanium alloys, that are used for the individual profiles or the protective element. A face-centered cubic modification of the crystal structure here in particular takes place.

As a result, it is possible that the preform of the protective element be quenched and tempered after being heated to the austenitizing temperature, wherein the quenching and tempering can, for example, take place in a cooled shaping mold after or during final shaping by hot-forming and press hardening. Quenching and tempering is a combined heat treatment consisting of hardening and subsequent tempering.

In general, although such quenching and tempering usually means the steel material, such quenching and tempering is also conventional in the case of non-ferrous metals such as, for example, magnesium alloys, aluminum alloys and titanium alloys, wherein a thermal microstructure formation and change takes place. For hardening, it is first necessary to heat the basic form of the protective element above the austenitizing temperature. Quenching is then carried out, i.e., a rapid cooling of the protective element, which is now finally shaped. The microstructure which forms is thereby influenced by the quench rate and is correspondingly adjustable by a person skilled in the art. An immediate tempering step is advantageous after quenching. The brittle tetragonal martensite formed on hardening of a steel is here transformed, with the precipitation of fine carbides, into the cubic martensite microstructure. This has a smaller volume and provides that the grain lattice of the crystal is relaxed, and removes the so-called glass hardness of the material. In this respect, this method step makes it possible to produce particularly effective protective elements having a correspondingly good protective action for a motor vehicle.

The method according to the present invention advantageously allows the advantages of quenching and tempering in a mold, in particular the complex forming and homogeneous hardness distribution in the component, to be combined with the advantages of the welded solution and the sharp-edged design of structures. Even though it is associated with an additional production step, this additional step is outweighed by the advantages achieved by the synergistic effect in terms of the protective action of the protective elements produced by the method according to the present invention.

A first embodiment of the present invention provides that the welding of the individual profiles to give a preform of the protective element is carried out with a formation of at least one weld seam on the strike-facing side of the individual profiles and at least one weld seam on the side of the individual profiles that is remote from the strike face.

It can alternatively of course also be provided that the welding of the individual profiles to give a preform of the protective element is carried out with formation of both weld seams on the strike-facing side of the individual profiles or on the side of the individual profiles that is remote from the strike face.

In a first advantageous embodiment of the method, a welding filler metal is used in the welding of the at least one weld seam located closer to the strike-facing side of the individual profiles, the welding filler metal having a higher hardness than a welding filler metal used in the welding of the at least one weld seam that is further away from the strike-facing side of the individual profiles. The strike resistance and thus the protective action of the protective element, in particular in the region of the weld seams, is thereby further increased.

A further advantageous embodiment of the present invention provides that an austenitic filler metal is used in the welding and formation of the weld seams. As already mentioned, such austenitic filler metals have the effect of compensating for the stresses during welding. Although such filler metals are not themselves strike-resistant, the protective action in the region of the weld seams is maximized by the final hardening according to the present invention and the formation of edges and the avoidance of bending radii.

The strike resistance and thus the protective action of the protective element according to the present invention is also increased further by the fact that a welding filler is used in the welding of the weld seam on the strike-facing side of the individual profiles, the welding filler metal having a hardness of greater than 550 HV. The welding filler metal can already have the hardness of greater than 550 HV after welding. The welding filler metal should, however, also have a hardness of greater than 550 HV during the final shaping and hardening.

The use of a ductile welding filler metal in the welding of the weld seam on the side of the individual profiles that is remote from the strike face also further increases the strike resistance and thus the protective action of the protective element according to the present invention, since the likelihood of the weld seam breaking is thus reduced.

A further embodiment of the present invention provides that, prior to welding, individual profiles that are to be welded together are arranged at an angle that is different from 180° in the region of the weld seams to be formed. It is thereby possible to produce in a simple manner protective elements such as, for example, an A-, B- or C-pillar, a front wall, a door sill, a hatch, a wheel arch, a vehicle floor or the like, which are often used in motor vehicles. The angle between two individual profiles can, for example, be from 45° to 150°, in particular from 90° to 120°.

It is additionally advantageous if the individual profiles are provided in the form of hot-formed, press-hardened profiles which, as a result of this corresponding pretreatment, already have a significantly better strike resistance and thus also an improved protective action.

The provision of at least one individual profile with a bending radius that is greater than twice the wall thickness of the individual profile also offers better strike resistance and thus also an improved protective action than individual profiles with smaller bending radii.

In the method according to the present invention, the final shaping of the basic form of the protective element to provide the protective element can be carried out substantially without the need for conventional shaping by bending. The small bending radii which are obtained in the case of conventional shaping by bending and which would mean weakening of the protective element and thus of the protective action of the protective element are thereby avoided, wherein the protective element may of course still be subjected to bending processes in the shaping mold. No further sharp edges, i.e., no small bending radii, are, however, produced during such bending processes. In this respect, the advantages known from quenching and tempering in a mold, i.e., complex forming and homogeneous hardness distribution within the protective element as a whole, are obtained, while at the same time the sharp-edged structures are formed in the region of the weld seams of two directly adjacent individual profiles of the protective element that are arranged relative to one another at an angle that is different from 180°.

In an embodiment of the present invention, shaping of the preform of the protective element takes place only in the region of the weld seams and optionally the weld seams of directly adjacent regions with formation of sharp edges. Other regions of the preform are no longer shaped during final shaping.

It has been found to be particularly expedient according to the present invention that the final shaping of the preform of the protective element to provide the protective element takes place substantially only by bending in the region of the weld seams between two directly adjacent individual profiles arranged relative to one another at an angle that is different from 180°, or in regions of these individual profiles bordering the weld seams. It is thereby possible to shape the preform substantially only in the region of these weld seams without the need for a material weakening in this region. The protective action in the region of the weld seams is thus in particular significantly increased compared to the protective elements known from the prior art without a substantial material weakening occurring in the region of the weld seams.

A further concept of the present invention provides that the individual profiles are provided from steel sheets, in particular as-rolled steel sheets, or from hardened steel sheets.

It is here possible that the individual profiles are provided in the form of individual profiles produced from a flat sheet-metal plate.

It is also possible that the individual profiles are provided in the form of individual profiles produced from steel which is already hardened, in particular, hardened protection steel.

With all these possible starting materials for the individual profiles, it is provided that the individual profiles provided have protective properties that are sufficient for the protective action and thus, even without after-treatment, have the required protective properties for use as a protective element in a motor vehicle, in particular in an armored military motor vehicle as well as in an armored non-military protection vehicle.

A further particularly advantageous concept of the present invention provides for the use of a wide variety of welding methods for welding the individual profiles. These in particular include laser welding, plasma welding, arc welding with a rod electrode, or also gas-shielded welding with filler wire, wherein the rod electrode or filler wire has substantially an analogous alloy composition to the individual profiles.

When laser welding or plasma welding is used, this is generally carried out as butt welding. The resulting weld seam in this respect substantially already has the analogous alloy composition to the individual profiles themselves. However, even in the case of the use of gas-shielded welding with filler wire, wherein the filler wire has substantially an analogous alloy composition to the individual profiles, a substantially homogeneous weld seam is produced which substantially corresponds in terms of its composition to the alloy composition of the individual profiles. It must in particular be provided in the case of the welding methods used that, when using filler metals, such as, for example, electrodes or wires, in the protective element to be produced, that these filler metals must have a ferritic form in order for microstructure transformation to take place.

An approximately homogeneous transition between the individual profiles is therefore formed as a result of quenching and tempering after the corresponding welding operation so that the protective element as a whole has a substantially homogeneous alloy composition, also in the region of the weld seams. During the final shaping, the weld seams are then shaped to provide the correspondingly sharp edges without the need to use bending processes that are disadvantageous for the protective action of the protective element.

It has further been found to be particularly expedient that the protective element produced be an A-, B- or C-pillar, a front wall, a door sill, a hatch, a wheel arch, a vehicle floor or the like.

The present invention also provides a protective element for a motor vehicle, wherein the hardness of the weld seam located closer to the strike-facing side of the individual profiles is greater than the hardness of the weld seam located closer to the side of the individual profiles that is remote from the strike face, wherein the hardness of the weld seam located closer to the strike-facing side of the individual profiles and the hardness of the original individual profiles vary by not more than 25%, wherein the hardness of the weld seam located closer to the strike-facing side of the individual profiles is at least 550 HV.

Further objectives, advantages, features and possible applications of the present invention will become apparent from the following description of exemplary embodiments with reference to the drawings. All the features that are described and/or depicted in the drawings form the subject matter of the present invention on their own or in any desired expedient combination.

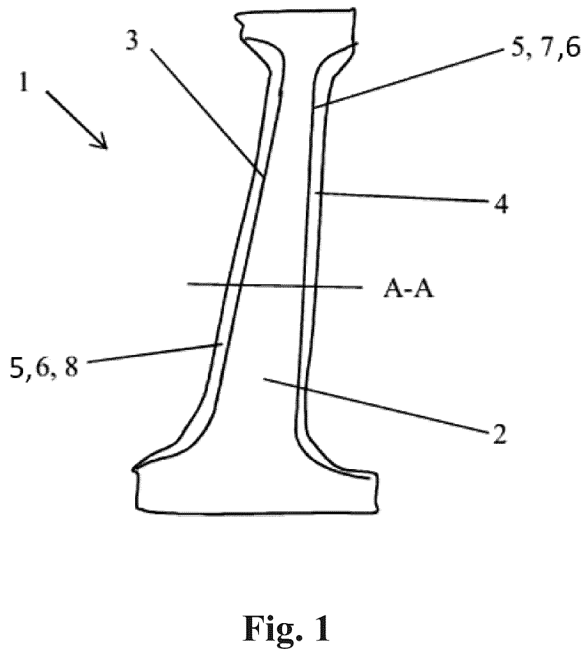

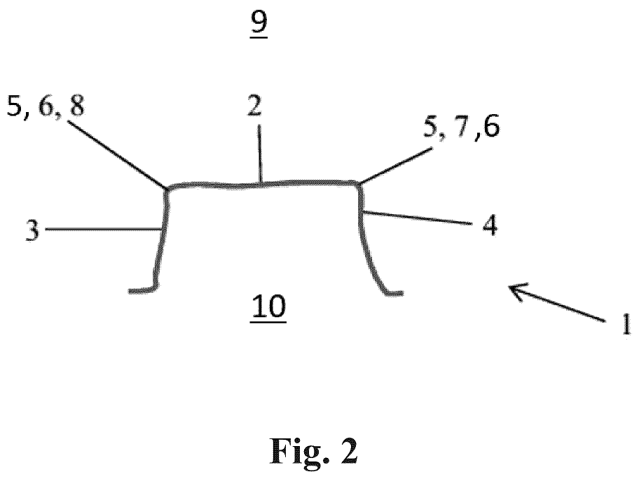

FIGS. 1 and 2 show an exemplary embodiment of a protective element 1 according to the present invention in the form of a B-pillar in a top view and in a cross-sectional representation, respectively. The protective element 1 here consists of three correspondingly preformed original individual profiles 2, 3 and 4. The individual profiles 2, 3 and 4 have already been cut and bent before production of the protective element 1 so that they can be joined together to give a preform of the protective element 1 without further shaping having to be carried out on the individual profiles 2, 3 and 4.

In order that the preform of the protective element 1 is dimensionally stable, the individual profile 2 and the individual profile 3 and the individual profile 2 and the individual profile 4 are connected together in each case by two weld seams 5 and 6. One weld seam 5 is located on a strike-facing side 9 of the protective element 1 and the other weld seam 6 is located on a side 10 of the protective element 1 that is remote from the strike face. Welding methods which can here be used are in particular laser welding, plasma welding, arc welding or gas-shielded welding with filler wire, wherein the filler wire in the case of gas-shielded welding has substantially an analogous alloy composition to the individual profiles 2, 3 and 4.

In the present case of the protective element 1 in the form of a B-pillar, the individual profiles 2, 3 and 4 consist of a corresponding steel. After the three individual profiles 2, 3 and 4 have been welded together to give the basic form of the protective element 1, wherein this basic form already has the finished form of the B-pillar, the basic form of the protective element 1 is then inserted into a cooled hot-forming mold in a press and is formed into the finished protective element in the form of a B-pillar by heat treatment with a subsequent final shaping. During shaping of the basic form of the protective element 1 in the hot-forming mold, the sharply formed edges 7 and 8 form in the region of the weld seams 5 and 6 between the individual profiles 2 and 4 and 2 and 3. This shaping in the press corresponds substantially to calibration, or bending, of the distortions introduced by the welding with formation of the desired geometry and in particular of the sharp edges 7 and 8. In order to complete the protective element, press hardening is finally carried out in the hot-forming mold, while the press mold remains closed, after or during the final shaping. The mold can in some circumstances also be immersed in or flooded with cooling medium and opened slightly and closed again several times in order to increase the cooling rate and minimize the cooling time and thus the press occupation time.

As is in particular apparent from the sectional representation of FIG. 2 along the sectional plane A-A of FIG. 1, the individual profiles 2 and 3 and the individual profiles 2 and 4 are arranged approximately at right angles of 90° relative to one another. It is thus possible via the production method, without the need for shaping by bending and thus without the need for material-weakening bending radii, to produce protective elements 1 which form sharp edges 7 and 8 in their connecting region of the weld seams 5 and 6. These sharp edges 7 and 8 are significantly more suitable for use in such protective elements 1 than bending radii which form in the case of the shaping by bending known from the prior art, and thus offer significantly more effective protection against ballistic attack and detonations.

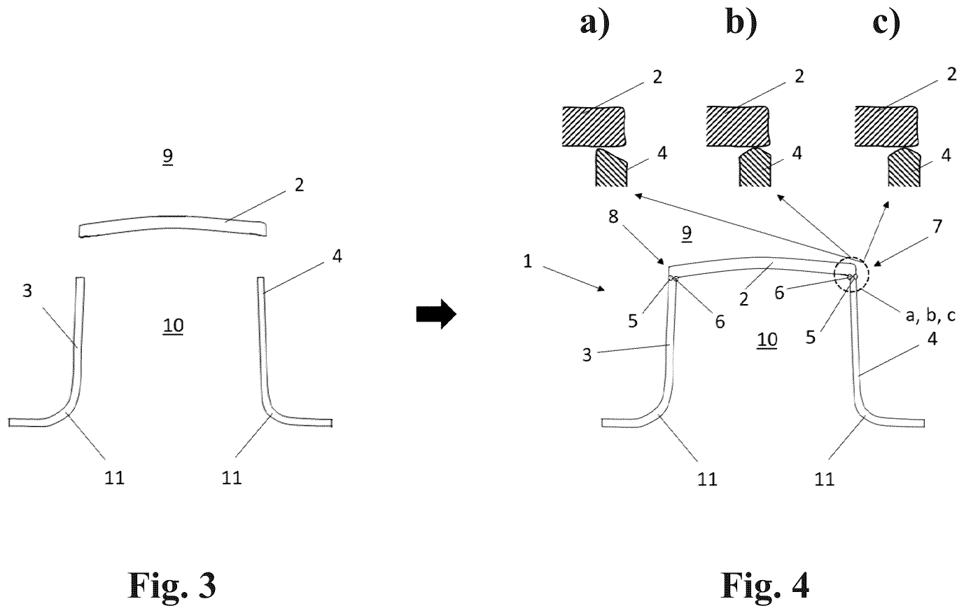

FIGS. 3 and 4 show a first exemplary embodiment of the method for producing a protective element 1 according to the present invention. The protective element 1, as is shown in FIG. 4, is here produced from individual profiles 2, 3 and 4. In order to produce the protective element 1, the individual profiles 2, 3 and 4 are first provided. The two individual profiles 3 and 4 have a bend with a bending radius 11 that is greater than twice the thickness of the individual profiles 3 and 4. The further individual profile 2 is welded at each of its ends to one of the individual profiles 3 and 4 to give a preform of the protective elements 1 with formation of at least one weld seam 5 on a strike-facing side 9 of the individual profiles 2, 3 and 4 and at least one weld seam 6 on the side 10 of the individual profiles 2, 3 and 4 that is remote from the strike facing side 10.

The individual profiles 3 and 4 are here provided with beveled edges in their end regions facing the individual profile 2, as is shown in the detailed representations a), b) and c) of FIG. 4. Beveling can be carried out before or during hot-forming of the individual profiles 3 and 4. The individual profiles 3 and 4 so beveled are then positioned on the individual profile 2 in the end region thereof, as is shown in the detailed representations a), b) and c) of FIG. 4. The individual profiles 3 and 4 are then welded to the individual profile 2. In each case, a strike-face weld seam 5 is produced on the strike-facing side 9 of the individual profiles 2, 3 and 4, and a weld seam 6 is produced on the side 10 of the individual profiles 2, 3 and 4 that is remote from the strike face, with formation of edges 7 and 8. Welding can be carried out with the same or different welding filler metals for both of the weld seams 5 and 6. It is important only that the strike-facing weld seam 5 has a greater hardness than the weld seam 6 on the side 10 of the individual profiles 2, 3 and 4 that is remote from the strike face.

After the individual profiles 2, 3 and 4 have been welded with formation of the weld seams 5 and 6, the resulting preform of the protective element 1 is inserted into a hot-forming mold in which final shaping of the preform to give the protective element 1 is carried out in the hot-forming mold. After the preform has been subjected to the final shaping in the hot-forming mold to give the protective element 1, a hardening of the protective element 1 is finally carried out. To this end, before shaping to give the protective element 1, the preform of the protective element 1 is heated to an austenitizing temperature and finally quenched and tempered, wherein this quenching and tempering is carried out in the cooled hot-forming mold after or during the final shaping by hot-forming and press hardening.

The protective element 1 shown in FIGS. 3 and 4 likewise constitutes a B-pillar of a motor vehicle.

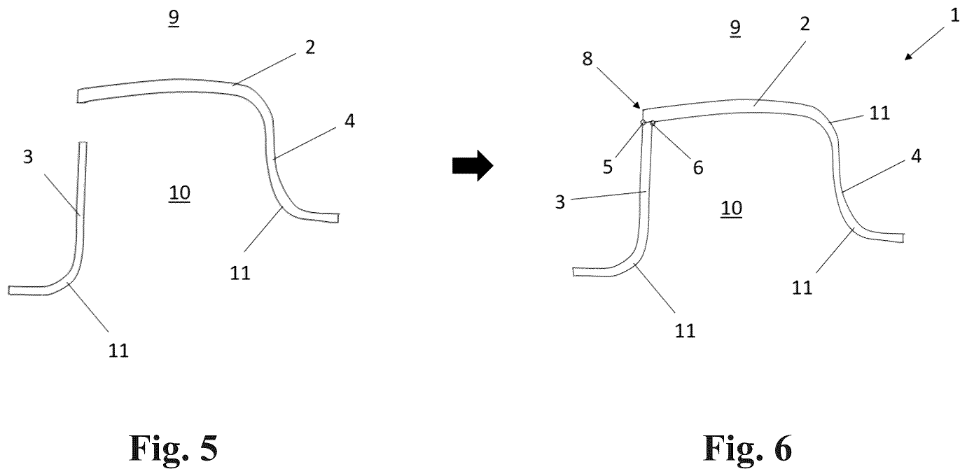

FIGS. 5 and 6 show a second exemplary embodiment of the method according to the present invention for producing a protective element 1 in the form of a B-pillar. In this case, however, only two individual profiles 2 and 3 are connected together according to FIG. 5. The individual profile 2 is here provided with two bends which have a bending radius 11 which is greater than twice the wall thickness of the individual profile 2. The bends are configured so that, after the bend, the individual profile 2 extends further bent through about 90°. The individual profile 2 of this exemplary embodiment corresponds to a combination of the individual profiles 2 and 4 of the exemplary embodiment of FIGS. 3 and 4. The individual profile 3 also has a bend with a bending radius 11 which is greater than twice the wall thickness of the individual profile 3.

The individual profile 3 in FIG. 6 has already been connected to the individual profile 2 with formation of the two weld seams 5 and 6. Final shaping and quenching and tempering with formation of the edge 8 has also already taken place. Shaping and quenching and tempering were likewise carried out in accordance with the procedure as described in relation to the exemplary embodiment of FIGS. 3 and 4. Welding can be carried out with the same or different welding filler metals for both of the weld seams 5 and 6. It is important only that the strike-facing weld seam 5 has a greater hardness than the weld seam 6 on the side 10 of the individual profiles 2, 3 and 4 that is remote from the strike face.

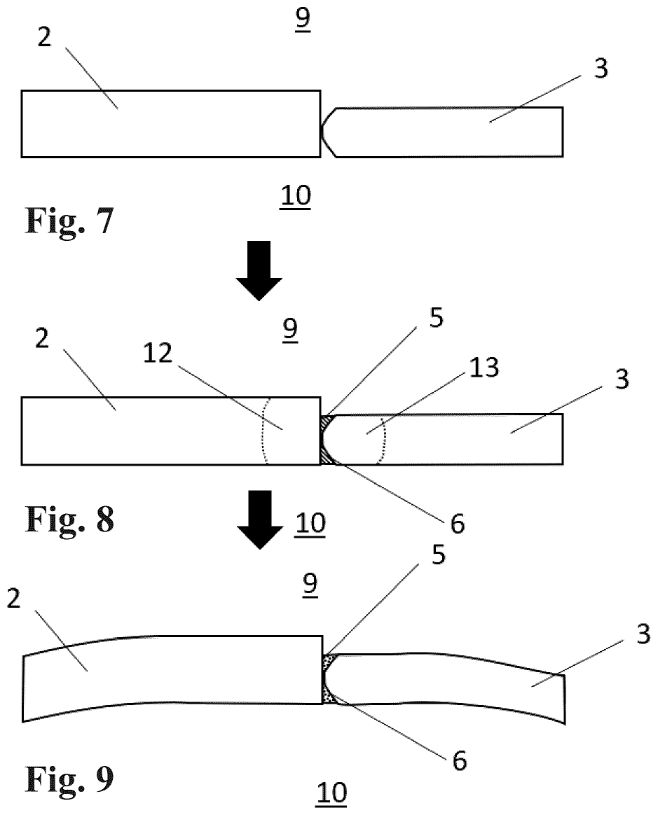

FIGS. 7 to 9 show a third exemplary embodiment for producing a protective element according to the present invention. Two individual profiles 2, 3 are here connected to provide a protective element 1. In the first method step, which is shown in FIG. 7, the individual profile 3 having a beveled end is provided and is applied to the individual profile 2 which is likewise provided.

In the further method step shown in FIG. 8, the individual profiles 2 and 3 are then connected together with formation of weld seams 5 and 6. The weld seam 5 is again located on the side 9 facing the strike face, while the weld seam 6 is located on the side 10 remote from the strike face. Welding of the two individual profiles 2 and 3 with formation of the weld seams 5 and 6 can again be carried out with the same or different welding filler metals. It is here significant that, however, during welding, heat-affected zones 12 and 13, in which the strike resistance and thus the protective action would be reduced, form within the individual profiles 2 and 3 in the region of the weld seams 5 and 6.

These heat-affected zones 12, 13 with reduced protective action are again hardened by the final quenching and tempering by hot-forming and hardening so that a protective element 1, as is shown in FIG. 9, is formed in which the heat-affected zones 12 and 13 with reduced protective action have been again removed or reduced to the maximum possible degree by quenching and tempering, or hardening.

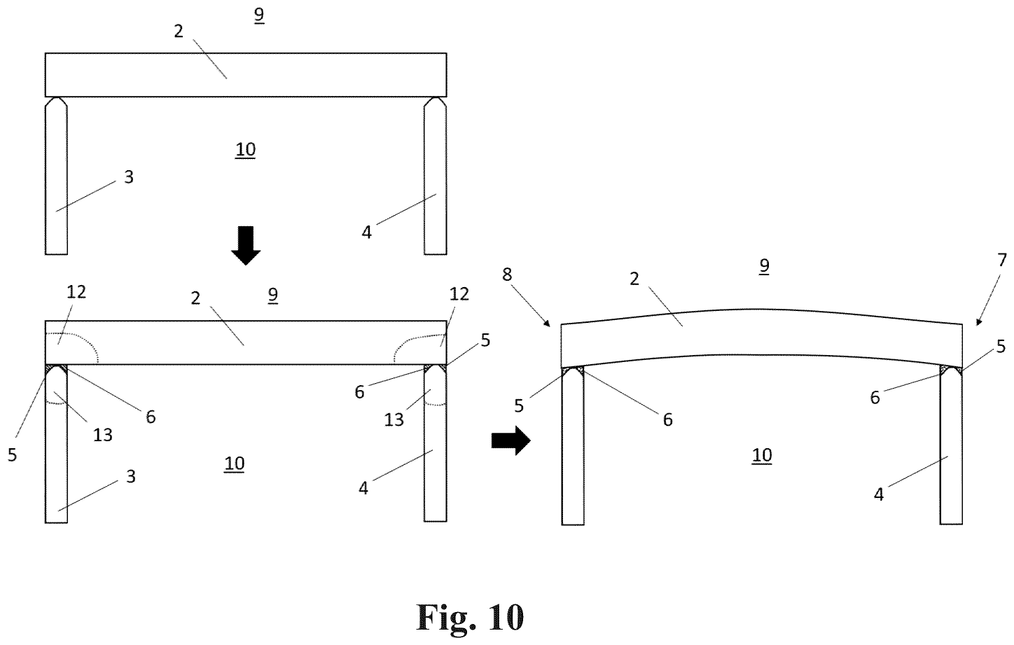

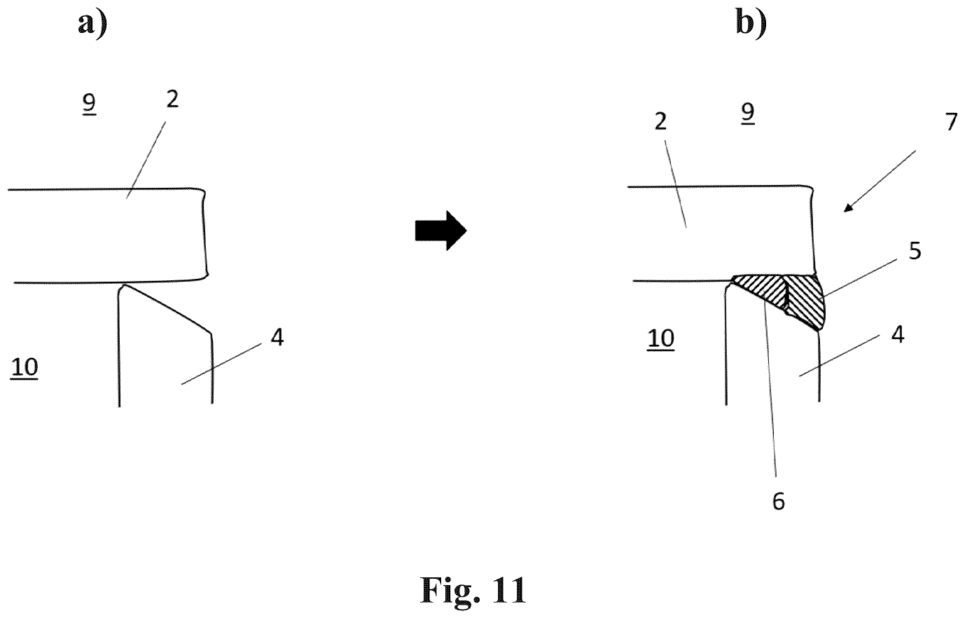

In the same manner, FIG. 10 shows a fourth exemplary embodiment for producing a protective element according to the method of the present invention which is analogous to the method shown in FIGS. 7 to 9, wherein the protective element 1 shown in b) of FIG. 11 has been produced from three individual profiles 2, 3 and 4. The protective element 1 of this exemplary embodiment can again be in the form of a B-pillar of a motor vehicle.

As is shown in FIG. 10, the individual profiles 3 and 4 therein are beveled at their end facing the further individual profile 2 and in the further method step (as is shown in FIG. 11) are connected together with formation of weld seams 5 and 6 and heat-affected zones 12 and 13. Welding can here also be carried out with the same or different welding filler metals for both of the weld seams 5 and 6. It is important only that the strike-facing weld seam 5 has a greater hardness than the weld seam 6 on the side 10 of the individual profiles 2, 3 and 4 that is remote from the strike face. In order to again minimize the heat-affected zones 12 and 13, quenching and tempering is again carried out in a final method step after or during hot-forming in a hot-forming mold. This quenching and tempering is again carried out with hot-forming and press-forming inside the hot-forming mold after or during final shaping of the preform to provide the protective element 1.

FIG. 11 shows a fifth exemplary embodiment for producing a protective element according to the method of the present invention. Here, instead of a weld seam on the side 10 remote from the strike face and a weld seam on the strike-facing side 9, only one weld region is formed, said weld region being of two-layered form in the form of a strike-facing, outer weld seam 5 and an inner weld seam 6 remote from the strike face. The two weld seams 5 and 6 of the weld region are formed in the gap between adjacent individual profiles 2 and 4 within a bevel of one of the individual profiles 4, as has also already been described in a) of FIG. 4. The inner weld seam 6 has a higher ductility and lower hardness and strength than the outer weld seam 5. What has already been stated above in connection with the exemplary embodiments already described in respect of the different weld seams 5 and 6 and correspondingly different welding filler metals also applies correspondingly for this exemplary embodiment. It is an additional advantage here that one-sided accessibility during welding of the individual profiles 2 and 4 and thus during production of the preform is sufficient, which in some circumstances can mean a greater degree of freedom in terms of component design and a lower outlay in terms of apparatus and handling in production.

The present invention is not limited to embodiments described herein; reference should be had to the appended claims.

LIST OF REFERENCE CHARACTERS

| | |
|---|---|
| 1 | Protective element |
| 2 | Individual profile |
| 3 | Individual profile |
| 4 | Individual profile |
| 5 | Weld seam/Strike face weld seam |
| 6 | Weld seam/Strike face remote weld seam |
| 7 | Edge |
| 8 | Edge |
| 9 | Side/Strike facing side |
| 10 | Side/Strike facing remote side |
| 11 | Bending radius |
| 12 | Heat-affected zone |
| 13 | Heat-affected zone |
| A-A | sectional plane |

What is claimed is:

1. A method for producing a protective element which is formed of individual profiles for armoring a motor vehicle, wherein at least two of the individual profiles are arranged adjacent to one another, the method comprising:
providing the individual profiles from a same steel alloy or from different steel alloys;
welding the individual profiles to provide a preform of the protective element;
heating the preform to a temperature which is higher than an austenitizing temperature of the steel alloy or, if the individual profiles are provided from different steel alloys, to a temperature of the steel alloy having a highest austenitizing temperature;
inserting the preform into a hot-forming mold;
subjecting the preform to a final shaping in the hot-forming mold to provide the protective element; and
hardening the protective element in the hot-forming mold,
wherein,
the welding of the individual profiles to provide the preform of the protective element is performed with a formation of at least two weld seams, and
a first weld seam of the at least two weld seams is located further away from a strike-facing side of the individual profiles than a second well seam of the at least two weld seams.

2. The method as recited in claim 1, wherein the welding of the individual profiles to provide the preform of the protective element is performed so that the first weld seam of the at least two weld seams is provided on a side of the individual profiles that is remote from the strike-facing side, and the second well seam of the at least two weld seams is provided on the strike-facing side of the individual profiles.

3. The method as recited in claim 1, wherein the welding of the individual profiles to provide the preform of the protective element is performed so that both the first weld seam and the second weld seam of the at least two weld seams are formed on the strike-facing side of the individual profiles or on the side of the individual profiles that is remote from the strike-facing side.

4. The method as recited in claim 1, wherein,
a welding filler metal having a hardness is used in the welding of the first weld seam of the at least two weld seams,
a welding filler metal having a hardness is used in the welding of the second weld seam of the at least two weld seams, and
the hardness of the welding filler metal of the second weld seam is higher than the hardness of the welding filler metal of the first weld seam.

5. The method as recited in claim 4, wherein at least one of the welding filler metals is austenitic.

6. The method as recited in claim 4, wherein the hardness of the welding filler metal of the second weld seam is greater than 550 HV.

7. The method as recited in claim 1, wherein, prior to the welding of the individual profiles to provide the preform of the protective element, the method further comprises:
arranging the individual profiles that are to be welded together at an angle that is different from 180° in a region of the at least two weld seams to be formed.

8. The method as recited in claim 1, wherein the individual profiles are provided in the form of hot-formed, press-hardened profiles.

9. The method as recited in claim 1, wherein at least one of the individual profiles is provided with a bending radius that is greater than twice a wall thickness of the individual profile.

10. The method as recited in claim 1, wherein the individual profiles are provided from steel sheets,

11. The method as recited in claim 10, wherein the steel sheets are rolled steel sheets or hardened steel sheets.

12. The method as recited in claim 1, wherein, during the final shaping in the hot-forming mold to provide the protective element, the final shaping of the preform takes place in a region of the at least two weld seams so as to maintain sharp edges.

13. The method as recited in claim 12, wherein the final shaping of the preform additionally takes place in regions which are directly adjacent to the at least two weld seams.

14. The method as recited in claim 1, wherein the protective element is an A-pillar, a B-pillar, a C-pillar, a front wall, a door sill, a wheel arch, a vehicle roof, a vehicle door, a vehicle floor, a hatch, or a sensor cover.

15. The method as recited in claim 1, wherein, during the final shaping of the preform in the hot-forming mold to provide the protective element, the at least two weld seams are shaped to a lesser extent than regions of the individual profiles which adjoin directly thereto.

16. A protective element for a motor vehicle which is produced pursuant to the method as recited in claim 1,
wherein,
a hardness of the first weld seam which is located further away from the strike-facing side of the individual profiles is less than a hardness of the second well seam which is located closer to the strike-facing side of the individual profiles,
the hardness of the second weld seam which is located closer to the strike-facing side of the individual profiles and a hardness of the individual profiles prior to performing the method vary by not more than 25%, and
the hardness of the second weld seam which is located closer to the strike-facing side of the individual profiles is at least 550 HV.
